(19) United States
(12) Patent Application Publication
(10) Pub. No.: US 2006/0159395 A1
(43) Pub. Date: Jul. 20, 2006

(54) Optical compensator array for dispersive element arrays

(76) Inventors: Alan Hnatiw, Stittsville (CA); Thomas Ducellier, Ottawa (CA); Eliseo Romolo Ranalli, Irvine, CA (US); Driss Touahri, Gatineau (CA)

Correspondence Address: Ralph A. Dowell of DOWELL & DOWELL P.C., 2111 Eisenhower Ave, Suite 406, Alexandria, VA, 22314, US

(21) Appl. No.: 11/300,440

(22) Filed: Dec. 15, 2005

Related U.S. Application Data
(63) Continuation-in-part of application No. 10/493,107, filed on Apr. 20, 2004.

(51) Int. Cl. G02B 6/34

(52) U.S. Cl. 385/37; 385/14

(57) ABSTRACT

An array of dispersive arrangements, for example an array of waveguide dispersive elements, is compensated with a set of optical compensators such as wedges or pairs of cylindrical lenses. The optical compensators are selected to achieve a pre-defined dispersion profile across the array of waveguide dispersive elements. The optical compensators can make corrections for fabrication errors or other errors in an optical system that includes the array of waveguide dispersive elements. A particular application is found in waveguide selective switches.

### RELATED APPLICATIONS

This application is a continuation-in-part of U.S. Ser. No. 10/493,107, filed May 20, 2003 and claims the benefit of U.S. Provisional Application No. 60/381,364 filed May 20, 2002, both of which are hereby incorporated by reference in their entirety.

### BACKGROUND OF THE INVENTION

The wavelength selective switch (WSS) technology taught in Applicant's above-referenced pending U.S. patent application Ser. No. 10/493,107 uses an array of waveguide-based dispersive elements (WDE) to demultiplex and multiplex DWDM signals to be processed by a MEMS element.

If made to satisfy defined tolerances, the WDE will all be sufficiently aligned in terms of central wavelength and the optical system will perform with satisfactory optical performance.

Depending upon the fabrication techniques employed to make the WDE array, there may be errors/imperfections in fabrication (for example due to gradient of index of refraction and process non-uniformity across wafer) that may introduce a wavelength shift that may be as large as 300 pm across an array of 5 WDEs.

There are a few known techniques to compensate for center wavelength shift in waveguide optical filters. With UV trimming, exposure to a high intensity UV light is used to permanently alter the index of refraction enabling a wavelength change of dispersive elements made with the UV exposed sections. With heat trimming, a localized high temperature source is used to create the permanent index change. With mechanical trimming, a fixture is attached to the waveguide device to create a permanent stress-induced change in index of refraction. Electro-optic or thermo-optic phase elements can be employed that, using an electrical command, impose a non-permanent but constant phase change across the waveguide dispersive region.

All of the above techniques have deficiencies in terms of cost to implement the solution, slow relaxation of the permanent index change (causing inabilities to accurately forecast the end-of-life performance), induced birefringence causing polarization sensitivity or need for closed-loop feedback.

### SUMMARY OF THE INVENTION

According to one broad aspect, the invention provides an apparatus comprising: an array of dispersive arrangements; an array of optical compensators arranged with respect to the array of dispersive arrangements so as to align dispersion angles corresponding to at least one wavelength to produce a defined relative dispersion profile.

In some embodiments, each optical compensator of the array of optical compensators comprises a wedge.

In some embodiments, each wedge has one of a discrete set of angles.

In some embodiments, each wedge comprises two wedge shaped pieces of birefringent material.

In some embodiments, each optical compensator comprises a plate glued to a supporting element with a wedge induced in the glue used to secure the plate to the supporting element.

In some embodiments, each dispersive arrangement comprises a waveguide dispersive arrangement.

In some embodiments, each dispersive arrangement comprises a waveguide dispersive arrangement having a waveguide facet, and wherein the supporting element for the glass plate comprises the waveguide facet.

In some embodiments, each dispersive arrangement comprises a diffraction grating.

In some embodiments, each optical compensator comprises: a positive lens element and a negative lens element arranged in sequence.

In some embodiments, the positive lens element and the negative lens element are cylindrical lens elements.

In some embodiments, the apparatus further comprises a support structure to which the negative cylindrical lenses are affixed, and to which the positive cylindrical lenses are affixed.

In some embodiments, the optical wedges have coefficients of thermal expansion selected to reduce temperature sensitivity of a system within which the array of wedges is installed.

In some embodiments, the glue has coefficients of thermal expansion selected to reduce temperature sensitivity of a system within which the array of wedges is installed.

In some embodiments, each optical compensator further comprises a plate glued to a supporting element with a wedge induced in the glue used to secure the plate to the supporting element, the glue having coefficient(s) of expansion selected to reduce temperature sensitivity of a system within which the array of wedges is installed.

In some embodiments, a waveguide selective switch comprises the apparatus as summarized above.

According to another broad aspect, the invention provides a method comprising: constructing an array of dispersive arrangements; measuring each dispersive arrangement to determine the relative dispersive properties of the arrangements; selecting an array of optical compensators to achieve a particular defined relative dispersion profile.

In some embodiments, the method further comprises: installing the array of optical compensators with respect to the array of dispersive arrangements.

In some embodiments, selecting an array of optical compensators to achieve a particular defined relative dispersion profile comprises: selecting an array of wedge each having one of a set of discrete wedge angles.

In some embodiments, the discrete angle of each wedge selected is the discrete angle that is closest to an ideal wedge angle.

In some embodiments, selecting and installing comprise: gluing a glass plate to each dispersive arrangement and inducing a wedge in the glue.

In some embodiments, selecting an array of optical compensators comprises providing pairs of lens elements, each pair comprising one negative element and one positive element; and installing each positive element vis-á-vis the negative element such that a resulting separation of respective optical axes of the pair of lenses realizes a desired correction in the relative dispersive profiles.

In some embodiments, the lens elements are cylindrical lens elements.

In some embodiments, the method further comprises: selecting pairs of cylindrical lens elements with differing focussing properties.

In some embodiments, installing comprises: installing each positive element in a fixed position; adjusting the negative element in situ and then affixing it in place.

According to another broad aspect, the invention provides a method comprising: processing a plurality of optical signals with an array of dispersive elements; processing the signals with an array of optical compensators arranged with respect to the array of dispersive arrangements so as to align dispersion angles corresponding to at least one wavelength to produce a defined relative dispersion profile.

### BRIEF DESCRIPTION OF THE DRAWINGS

FIG. 1A shows an uncompensated waveguide based dispersive arrangement;

FIG. 1B shows a waveguide dispersive arrangement equipped with a compensating wedge;

FIG. 1C shows an array of waveguide dispersive arrangements equipped with compensating wedges;

FIG. 2A shows an uncompensated diffraction grating;

FIG. 2B shows a diffraction grating with a compensating wedge;

FIG. 2C shows an array of two diffraction gratings equipped with respective compensating wedges;

FIG. 2D shows an array of five diffraction gratings with respective compensating wedges;

FIG. 3A is a top view of a combined hybrid waveguide and MEMS ROADM embodiment with 4 drop ports and 5 wavelength channels provided by an embodiment of the invention, with discrete coupling optics;

FIG. 3B is a side view of the embodiment of FIG. 3A;

FIG. 4A is a top view of a preferred embodiment of a hybrid waveguide and MEMS ROADM with 4 drop ports and 5 wavelength channels as per an embodiment of the invention, in which integrated optics provide an array of dispersion elements and an array of coupling optics;

FIG. 4B is a side view of the embodiment of FIG. 4A;

FIG. 5A is a top view of an alternate embodiment of the invention featuring multiple waveguide substrates stacked on top of each other and having MEMS elements which are capable of tilting in two dimensions;

FIG. 5B is a side view of the embodiment of FIG. 5A;

FIGS. 6A and 6B is a layout view of an embodiment of the invention where two waveguide devices or waveguide device stacks are used in conjunction with transmissive switches capable of steering light beams in two dimensions;

FIG. 7 is a schematic layout view of the waveguide device of the hybrid waveguide and MEMS ROADM of FIG. 4A designed for 40 wavelength channels at 100 GHz spacing;

FIG. 8A is a top view of an embodiment of the invention in which the function of the main cylindrical lens is encoded into the phase profile of the waveguide dispersive elements;

FIG. 8B is a side view of FIG. 8A;

FIG. 9 is a system diagram of a wavelength selective switch employing free-space elements and an array of diffraction gratings, provided by an embodiment of the invention;

FIG. 10 is a system diagram of a wavelength selective switch employing free-space elements, an array of diffraction gratings and a 2D arrangement of optical ports, provided by an embodiment of the invention;

FIG. 11 is a plot comparing the performance of a wavelength selective switch with and without compensating wedges;

FIGS. 12A and 12B are flowcharts of methods of installing an array of compensating wedges;

FIGS. 13A and 13B show arrays of dispersive elements with and without compensation respectively, with the compensation being applied using glue wedges;

FIG. 13C shows an array of dispersive elements with glue wedges for compensating for coefficient of thermal expansion, and wedges for aligning outputs of the dispersive arrangements;

FIG. 14 is a schematic diagram of an array of ports with compensation using a pair of cylindrical lenses per port;

FIG. 15 shows details of a particular port in which no compensation is required; and

FIG. 16 shows details of a particular port in which compensation is required.

### DETAILED DESCRIPTION OF THE PREFERRED EMBODIMENTS

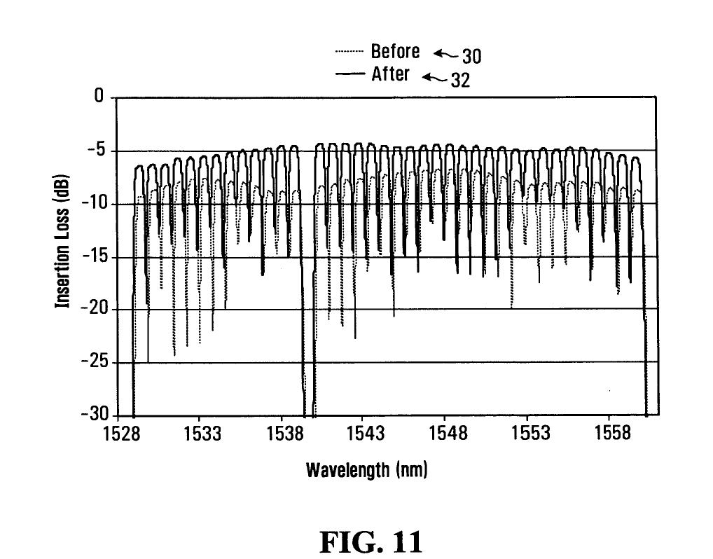

By way of introduction, FIG. 11 is a plot of the optical performance of a particular example implementation of a WSS employing a WDE array showing the performance without any WDE array compensation in “before” curve 30. It can be seen that the “before” curve 30 shows a high insertion loss and high insertion loss non-uniformity across the channels.

Regardless of the way an array of dispersive elements is put together (on the same substrate for a WG element, on a stack of WG, glued to a plate or other mounting mechanism), there is a need to precisely align each dispersive arrangement with respect to the others if they are to work together well. The alignment tolerance on those parts can be particularly tight, making an optomechanical mount prohibitively expensive or requiring that the array be fabricated as one monolithic assembly with very high precision.

Embodiments of the invention provide various techniques for compensating a WDE array and thereby relax alignment tolerances and/or fabrication tolerances. For example, in one embodiment of the invention, a compensated WDE is provided that employs small optical wedges inserted in a free-space section between the WDE and the light processing elements. An example of the type of performance improvement that can be realized with these techniques can be seen with further reference to FIG. 11. The “after” curve 32 shows the performance of the same WSS equipped with a compensated WDE array. The performance improvement in this particular instance is dramatic and enables the cost-effective manufacture of a WDE array all centered on the same wavelength.

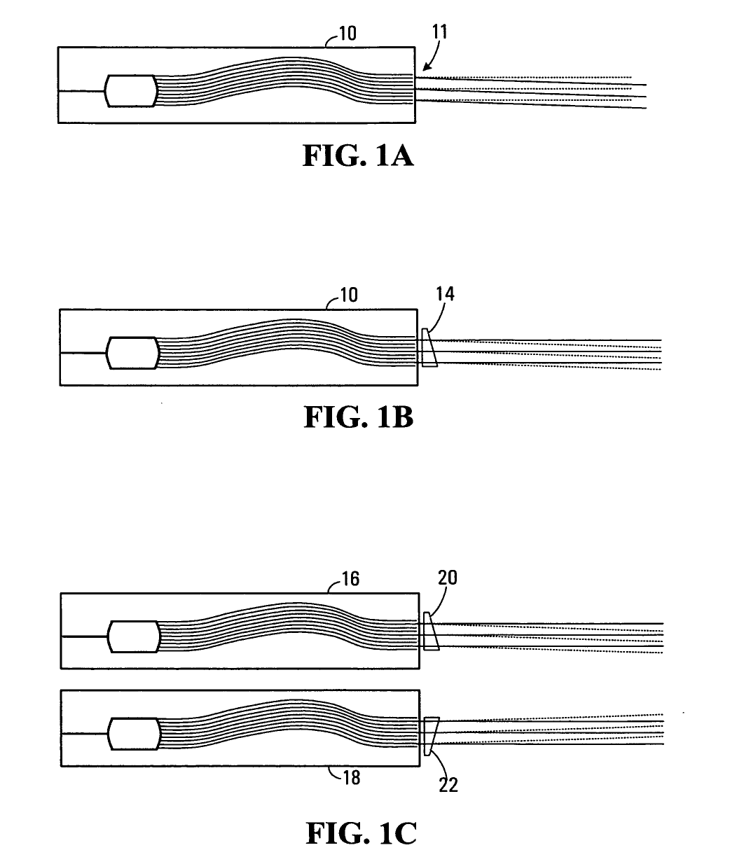

FIG. 1A shows a waveguide based dispersive element 10. This WDE is a transmissive dispersive arrangement. Details of an example implementation of such a WDE can be found for example in Smit (M. K. Smit, Electronics Letters, Vol. 24, pp. 385-386, 1988). More generally, any waveguide based dispersive arrangements can be employed. For a WDE 10 designed such that a given wavelength λc exits the waveguide perpendicular to the exit facet, if the fabrication of the waveguide device and the dicing and polishing of its facet are perfect, then λc is indeed exiting perpendicular to the waveguide facet as shown in FIG. 1A at 11. However, in practice, there is often a small deviation due to imperfections in the deposition of materials, gradient of index of refraction in the layers, imperfection in the photomask and lithographic process, imperfection in dicing and polishing, or other errors that lead to angular mispointing. In such a case, the angular deviation can be compensated for by inserting an appropriate wedge 14 as illustrated in FIG. 1B. For a WDE array, either integrated on the same substrate, or fabricated on different substrates and held in relative position, a wedge array can be assembled to compensate for each WDE so as to produce a given result. An example if this is shown in FIG. 1C where for two WDEs 16,18, respective wedges 20,22 are provided. More generally, any number of dispersive arrangements can be included in the array. The result is that both compensated WDEs have angles for λc that are parallel with each other and perpendicular to the waveguide facet(s). Other pre-defined relative positionings are possible.

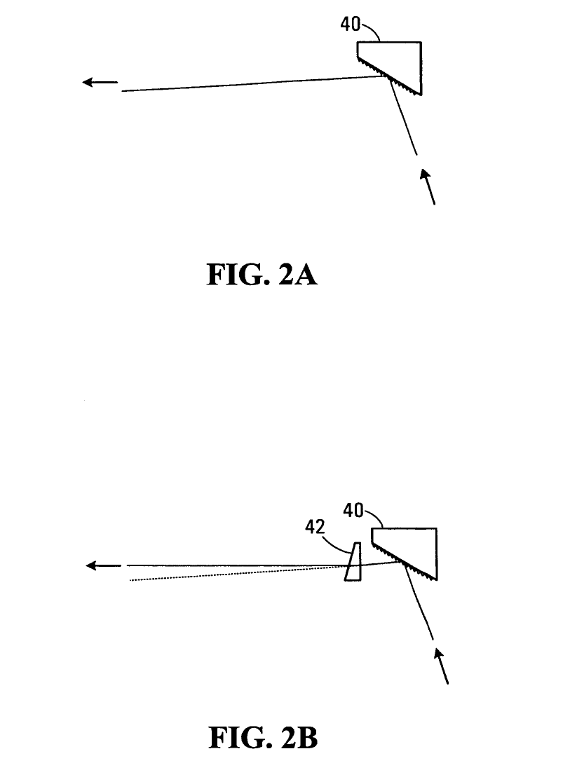

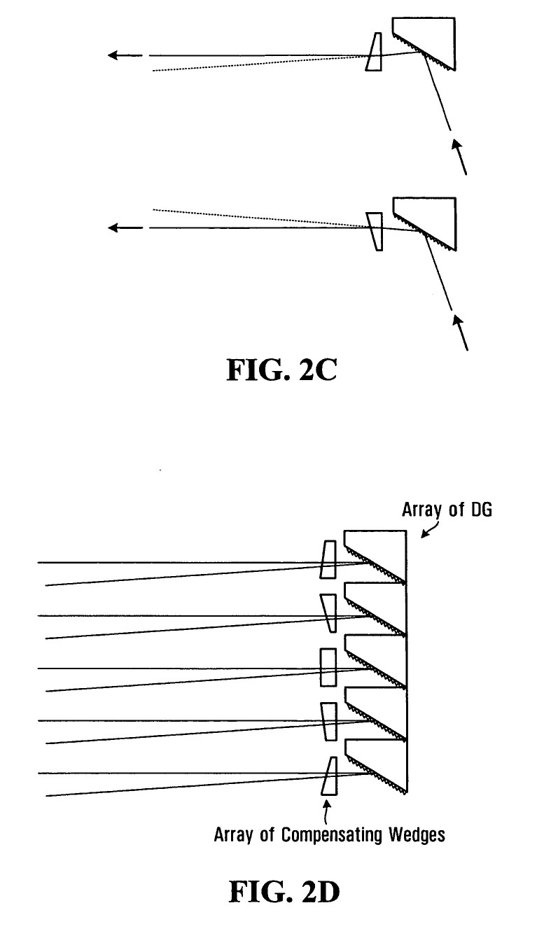

FIGS. 2A and 2B are similar to FIGS. 1A and 1B, but applied to the particular case of a diffraction grating. A diffraction grating 40 is shown in FIG. 2A, and shown again in FIG. 2B with a compensating wedge 42. Any number of dispersive arrangements can be included in the array.

FIGS. 2C and 2D show arrays of diffraction gratings. FIG. 2C shows an array of two diffraction gratings, while FIG. 2D shows an array of five diffraction gratings. More generally, any number of dispersive arrangements can be included in the array. In each case, an array of wedges is inserted in the light paths of each dispersive arrangement to realign the angles to a predefined pattern (parallel to each other in the example of this figure).

The examples of FIGS. 1 and 2 described above feature the use of waveguide dispersive elements and diffraction gratings. More generally, any dispersive arrangements can be used. Other examples include echelle gratings, optical phase arrays, etc.

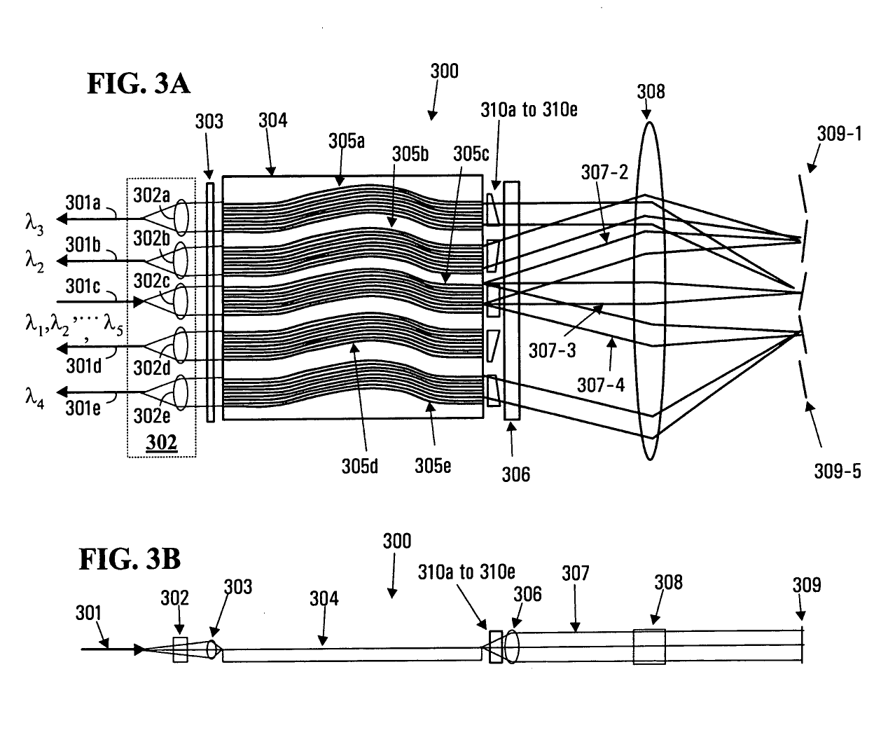

While arrays of wedges are employed in the above examples, more generally an array of optical compensators arranged with respect to the array of dispersive arrangements so as to align dispersion angles corresponding to at least one wavelength to produce a defined relative dispersion profile can be employed. It may be that dispersion angles are not aligned for all wavelengths, but they are aligned for at least one wavelength of interest. Examples of other optical compensators are given below and include cylindrical lens pairs and glue wedges. Several detailed examples of applications of the compensated array of dispersive arrangements will now be presented with reference to FIGS. 3 to 10. The particular applications of FIGS. 3 to 10 are WSS applications. However, the array of compensating wedges have other applications, for example Mux-Demux, Optical performance monitor, spectrometer, etc. Generally it can be applied in any application employing dispersive arrangement arrays.

It is noted that in the embodiment of FIG. 3A described below, and in other WSS embodiments, the description deals specifically with dropping wavelength channels. Usually this involves a single input port and multiple output ports. Alternatively, these same embodiments can function to add wavelength channels simply by interchanging the roles of the ports. Thus for example, a one input port, four drop (output) port implementation can equally function as a one output port, four input (add) port implementation.

FIG. 3A shows a top view of a hybrid waveguide and MEMS ROADM 300 provided by an embodiment of the invention having one input port 301c, four output ports 301a, 301b, 301d, 301e and five wavelength channels λ₁, λ₂, λ₃, λ₄, λ₅. The physical ports are any suitable optical port implementation. For example, each port might be a single mode optical fibre or a waveguide. An input DWDM light beam containing five wavelength channels λ₁ . . . λ₅ is input to the device 300 through input port 301c. The light beam is coupled to a waveguide device 304 through a micro-optics coupling scheme consisting of cylindrical lens 302c substantially collimating the light in the plane of the figure, while letting the light go through unaffected in the orthogonal plane and cylindrical lens 303 substantially re-focussing the light in the plane perpendicular to that of the figure while letting the light traverse unaffected in the plane of the figure. The cylindrical lens 303 and cylindrical lens 302a, 302b, 302d, 302e provide coupling optics for output ports 301a, 301b, 301d, 301e respectively. The transformed elliptical light beam (substantially collimated in the plane of the figure and substantially focussed in the plane perpendicular of the figure) is coupled to the waveguide region 305c of a waveguide device 304. This waveguide region 305c consists in an array of waveguides arranged such that a predetermined path length variation is spread across the array. This arrangement is known to a man skilled in the art to provide a waveguide based dispersive element (M. K. Smit, Electronics Letters, Vol. 24, pp. 385-386, 1988). Therefore the light exiting waveguide section 305c exhibits an angle dependent on the wavelength according to design parameters of the waveguide section 305c.

Throughout this description, a wavelength channel is an arbitrary contiguous frequency band. A single wavelength channel might include one or more ITU wavelengths and intervening wavelengths for example. Even though the expression “λ” is referred to herein in respect of a wavelength channel, this is not intended to imply a wavelength channel is a single wavelength only.

For ease of description, three out of the five wavelength channels (for example λ₂, λ₃, λ₄) have been shown in the portion of FIG. 3A to the right of waveguide device 304 although all five would be present at the exit of the waveguide device 305c. These demultiplexed light beams 307-1 to 307-5 first traverse cylindrical lens 306 which does not affect the light propagation in the plane of the figure, but substantially collimate the light in the perpendicular plane. A main cylindrical lens element 308 is used to focus the light in the plane of the paper, while not affecting light propagation in the perpendicular plane, making each demultiplexed light beam 307-1 to 307-5 incident upon a switching element 309-1 to 309-5. These switching elements in one embodiment consist of tilting micro-mirrors used to redirect the light at a selectable angle. There can be one tilting micro-mirror per wavelength channel.

After reflection from the mirror array 309-1 to 309-5, the light beams 307-1 to 307-5 are focussed in a plane perpendicular to the plane of the waveguide device 304 by cylindrical lens 306 and are collimated in the plane of the waveguide device 304 by cylindrical lens 308. In the preferred embodiment, the lens 308 is arranged such that the end of the waveguide device 304 and the switching array 309 are placed at the lens focal planes, guaranteeing that irrespective of the tilting angle of the MEMS array 309-1 to 309-5, the angle of incidence of the light beams 307-1 to 307-5 when they couple back to the waveguide device 304 is substantially the same as the angle upon exit of the waveguide device 304. Therefore when the MEMS tilt angle is controlled in such a way that the light beams 307-1 to 307-5 are aligned with any of the waveguide sections 305a to 305e, this construction allows for an efficient coupling and re-multiplexing of the light beams into exiting light beams coupled to the output ports 301a, 301b, 301d, 301e through coupling optics 302a, 302b, 302d, 302e described earlier.

An array of wedges 310a to 310e such as described previously is shown consisting of one wedge per dispersive arrangement to compensate the dispersive elements or to compensate the dispersive elements in combination with their relative positioning error with optical components.

Here, each wedge 310a to 310e compensates for the angular dispersion error of each of the dispersive elements 305a to 305e. In this particular dispersive arrangement array, the wedges are selected such that for each WDE, λc angles are all parallel and parallel with the optical axis of main lens 308.

The effect of wedges on collimated beams 307-1 to 307-5 is to add a slight additional angle (corresponding approximately to the wedge angle divided by the index of refraction of the material used to make the wedge) so as to realign the angle corresponding to λc with the optical axis of the main lens 308.

FIG. 3A shows waveguide dispersive elements in the form of an array of waveguides. More generally, an embodiment like that of FIG. 3A can employ any suitable waveguide dispersive arrangement. For example, one can use Echelle gratings etched into the waveguide.

FIG. 3A shows micro-optics coupling scheme in the form of cylindrical lenses 302 and collimating lens 303. Other micro-optics arrangements can employed, for example, gradient-index rod lens (Selfoc®, from NSG America) or other types of lens to the same effect.

FIG. 3A shows switching elements in the form of MEMS array 309. Alternatively one can use various other beam steering elements, like liquid crystal beam steering elements, programmable diffraction gratings, phase arrays, tilting prisms, or moving lens. More generally, routing elements can be employed. Routing elements may perform a switching function and hence also be switching elements, or may perform only a static routing function.

FIG. 3A shows a cylindrical lens 308 which performs routing between the dispersive elements and the routing elements. More generally, a bulk optical element having optical power can be employed. For the purpose of this description, a bulk optical element having optical power can be a curved mirror or a lens. Various types of lenses can be employed for different applications. All the wavelength channels pass through the bulk optical element in the case of it being a lens, or reflect off the bulk optical element in the case of it being a curved mirror. In some embodiments, such as the embodiment of FIG. 3A, the wavelength channels all pass through the bulk optical element having optical power twice, once on the way towards the routing elements and once on the way back. In other embodiments, such as those featuring transmissive switching elements described below, there are multiple bulk optical elements having optical power. However, the constraint that all the wavelength channels to be routed pass through each bulk optical element having optical power remains the same.

To simplify the description of this embodiment, it is shown as being a four drop ROADM with five wavelength channels, although it is to be understood that different numbers of ports and different numbers of wavelength channels can be accommodated by proper design of the array of waveguide dispersive elements and array of switching elements.

In some embodiments, the cylindrical lens 308 is put substantially in-between the waveguide device 304 and the switching array 309 whereby the optical distance between the waveguide device 304 and the cylindrical lens 308 and the optical distance between the cylindrical lens 308 and the switching array 309 are each substantially equal to the effective focal length of the cylindrical lens 308. This system, known to one skilled in the art as a “4 f system” is beneficial to obtain good coupling from and to the waveguide element 304 (telecentric imaging system). If the micro-mirrors 309 are further able to tilt in the plane perpendicular to that of the figure, a “hitless” operation can be guaranteed by arranging the switching in the subsequent steps of: first moving the beams 307 out-of-the plane of the figure (by tilting the micro-mirrors in a plane perpendicular to that of the figure), then steering the beams 307 to their appropriate location in the plane of the figure (by tilting the micro-mirrors in the plane of the figure) and finally establishing the coupling by aligning the beams 307 axis with that of the substrate of the waveguide device 304 (by tilting the micro-mirrors in a plane perpendicular to that of the figure an opposite amount to that imparted in the first step of the switching sequence). This switching sequence guarantees that upon switching, the light beams 307 only couple to their appropriate output ports and there is no crosstalk into other output ports.

After being reflected and re-directed by micro-mirrors 309-1 to 309-5, the light beams 307-1 to 307-5 propagate back to the waveguide device 304 through cylindrical lenses 308 and 306. Due to the geometry of the above mentioned 4f system, when the tilt angle of the micro-mirrors 309 are properly adjusted, each beam 307-1 to 307-5 can be routed to any of the waveguide dispersive elements 305a to 305e with good coupling performance. This is the consequence of the telecentricity of the 4 f arrangement, which guarantees that the exit angle of the beams 307-1 to 307-5 upon exit of the waveguide element 304 and the angle of incidence of these beams while coming back to the waveguide-element 304 are parallel, matching the dispersion requirement for the different waveguide dispersive elements 305a to 305e. For example, the demultiplexed beam 307-3 corresponding to λ₃ is exiting the waveguide device 304 from the middle waveguide dispersive element 305c with 0 degree angle. After being routed to MEMS device 309-3 by cylindrical lens 308, it is reflected with an angle dependent on the MEMS tilt setting. In the case depicted on the figure, the mirror sends the beam 307-3 upwards. It strikes the upper portion of the cylindrical lens 308 and is routed back to the waveguide device 304. With proper selection of the tilt angle of the MEMS 309-3, the beam 307-3 is precisely aligned to the waveguide dispersive element 305a. Because of the telecentricity of the 4 f system, the beam 307-3 is incident onto the waveguide dispersive element 305a with again 0 degree angle, which is required for efficient coupling at wavelength λ₃. The discussion above is made with the assumption that all WDE 305a to 305e are identical. In practice, small fabrication errors may cause angles to differ from their nominal values and thus to correct these errors wedges 310a to 310e are inserted.

Once all beams 307-1 to 307-5 have re-entered the waveguide device 304 at their respective waveguide dispersive elements 305a to 305e (in a completely selectable manner), they are coupled to their respective optical ports 301a to 301e.

FIG. 3B shows a side view of the embodiment of FIG. 3A. This shows clearly that cylindrical lens element 303 is substantially re-focussing the light beam between ports 301a to 301e and the waveguide device 304, while cylindrical elements 302a to 302e have virtually no impact on the light beam in the plane of the figure. The same holds true for cylindrical lens 306 used to substantially collimate light beams 307-1 to 307-5 upon exit of the waveguide device 304, while cylindrical lens 308 has virtually no effect on light propagation in the plane of the figure.

In the above embodiment, the routing elements are set to direct substantially all the light of a given wavelength channel towards the selected output port. In another embodiment, one or more of the routing elements are adapted to controllably misdirect a given wavelength channel such that only part of the light is directed to the selected output port, the rest being lost. This allows a wavelength channel specific attenuation function to be realized. In yet another embodiment, one or more of the routing elements are adapted to misdirect a given wavelength channel such that substantially none of the light is directed to any output port. This results in a channel block capability. The modifications are also applicable to the below-described embodiments.

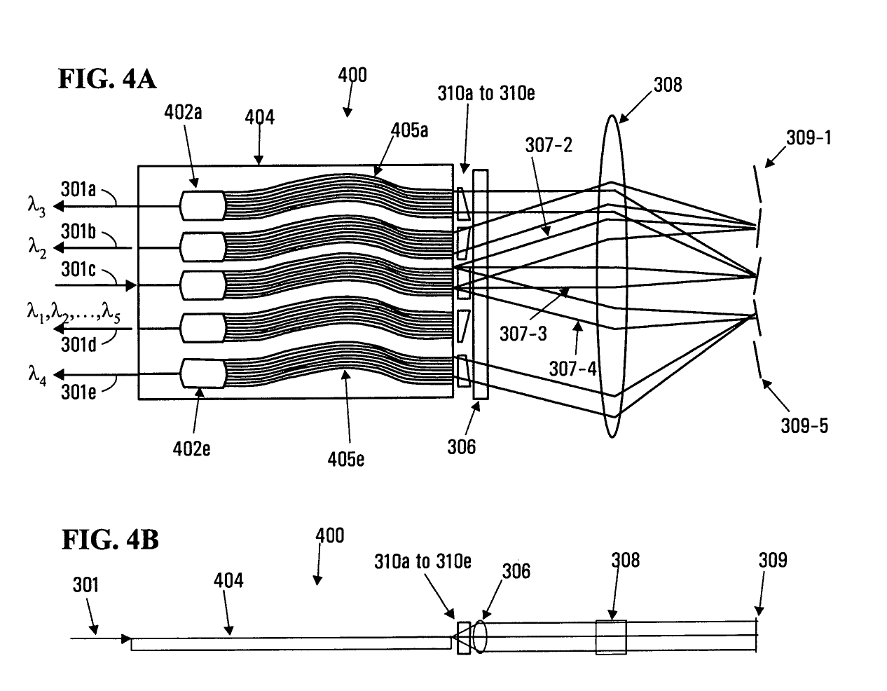

FIG. 4A shows a hybrid waveguide and MEMS ROADM 400 provided by another embodiment of the invention. The embodiment of FIG. 4A is similar to that of FIG. 3A described above. There are output ports 301a, 301b, 301d, 301e and input port 301c as before. However, in this embodiment there is no micro-optic coupling scheme provided external to the waveguide device for coupling light to and from the input ports to the waveguide device. Instead, a different waveguide device, generally indicated at 404 is provided. This waveguide device is the same as the device 304 of FIG. 3A with the exception of the fact that it includes integrated coupling optics 402a, 402b, 402c, 402d, 402e for coupling to and from the waveguide arrays, now designated as 405a through 405e of waveguide device 404, and the ports 301a through 301e. The remainder of the structure and operation of the embodiment of FIG. 4A is the same as that described above for FIG. 3A. This enables a more compact design with a more stable relative alignment. It is to be understood that arbitrary arrangements of add and drop ports can be provided without departing from the scope of the invention.

This coupling optics 402 for each waveguide array of dispersive elements consists of a slab waveguide ending on an arc where the waveguide array of dispersive elements is connected. This arrangement is known to one skilled in the art as a star coupler (C. Dragone, IEEE Photonics Technology Letters, Vol. 1, No. 8, pp. 241-243, August 1989).

FIG. 4B is a side-view of the embodiment of FIG. 4A.

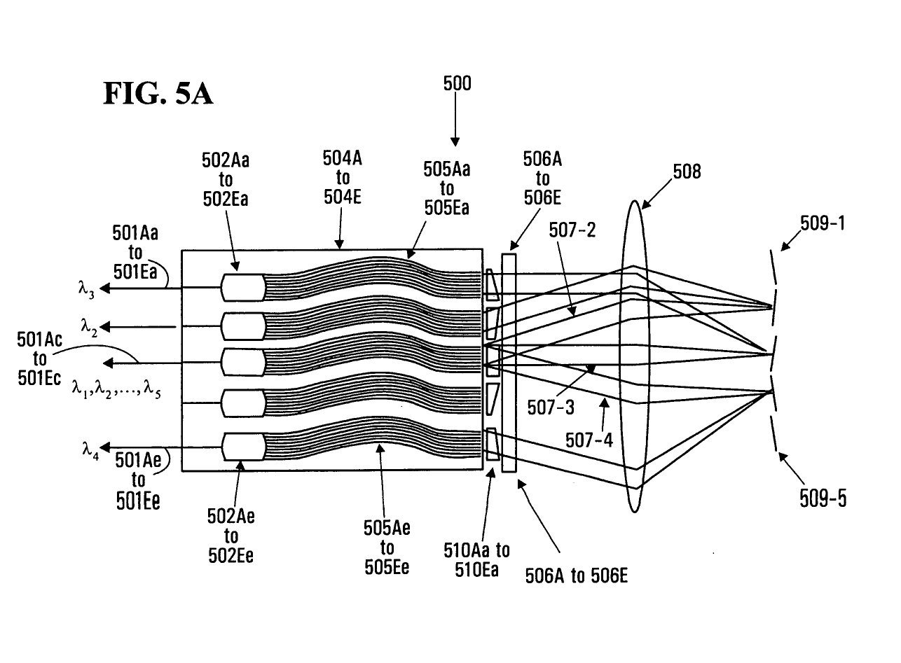

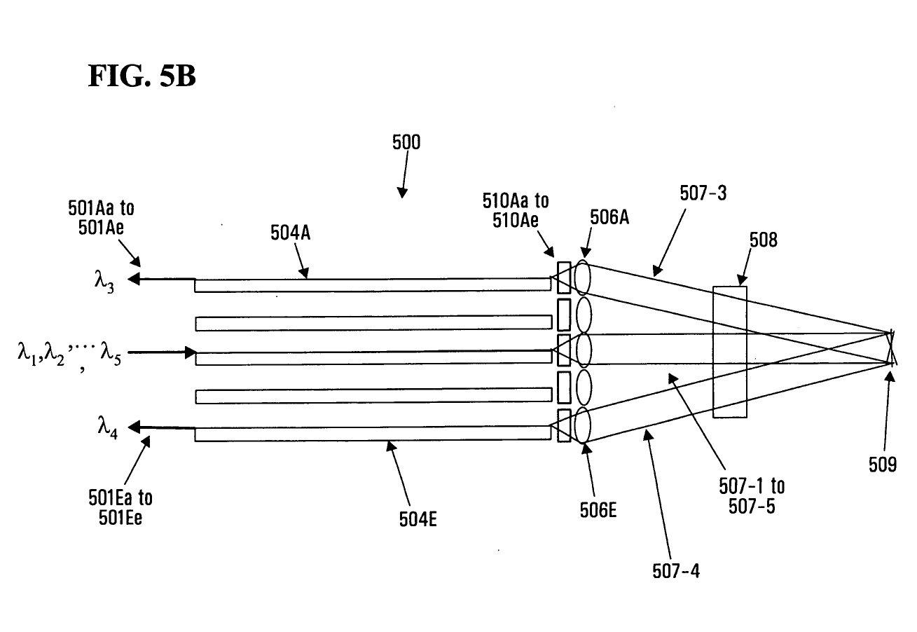

Referring now to FIGS. 5A and 5B, an alternate embodiment of the invention employs a stack of waveguide devices 504A to 504E. This enables the number of optical ports to be greatly increased. Although the example shown in FIGS. 5A and 5B contains only five stacked waveguide devices 504A to 504E, yielding 5×5=25 optical ports (from 501Aa to 501Ee), it is to be understood that any arbitrary number of such stacked waveguide devices can be used by proper design of the associated optics elements 506A to 506E and bulk optical element 508, and by providing switching means 509 capable of switching in two dimensions with a large enough tilt angle. Similarly, the choice of a 5 wavelength channels system is arbitrary and any larger or lower number of wavelengths can be routed in the multi-ROADM device 500 by appropriate design of the waveguide dispersive elements 505. In the description of FIGS. 5A and 5B, capital letters A to E refer to vertical axis (plane of FIG. 5B), while lower case letters a to e refer to horizontal axis (plane of FIG. 5A).

The stacked arrangement of FIGS. 5A and 5B include a respective waveguide device 504A through 504E for each layer. Layers 504A, 504B, 504D and 504E have respective sets of output ports. The output ports of device 504A are ports 501Aa through to 501Ae. Similarly the output ports of device 504E are ports 501Ea through to 501Ee. The waveguide device 504C also has an input port. The input port for device 504C is port 501Cc. The remaining ports 501Ca, 501Cb, 501Cd and 501Ce of device 501C are output ports. Thus, there is an array of 25 ports, one of which is an input port (501Cc) and 24 of which are output ports. This is an example configuration used for description of the invention. Other combinations of input and output ports are possible without departing from the spirit of the invention. In the illustrated embodiment, there is one input port and the remaining ports are output ports. In another embodiment, all of the ports are input ports except one which is an output port. In yet another embodiment, there are multiple input ports and multiple output ports. This last arrangement is not fully non-blocking. Each device 504A to 504E functions in the same manner as device 404 of FIG. 4. The arrangement 500 further includes for each waveguide device 504A through 504E a respective cylindrical lens 506A through 506E. There is also provided a single bulk optical element 508. There is an array of switching elements 509 shown most clearly in the view of FIG. 5A, each of which are capable of tilting in two dimensions, including tilting in the plane of FIG. 5A, and tilting in the plane of FIG. 5B. Tilting in the plane of 5A allows switching between different ports of the same device 504A to 504E and tilting in the plane of FIG. 5B allows switching between ports of different waveguide devices.

A two dimensional array of wedges 510Aa to 510Ee such as described previously is shown consisting of one wedge per dispersive arrangement to compensate the dispersive elements or to compensate the dispersive elements in combination with their relative positioning error with optical components.

Each of the ports (both input and output) are coupled to a respective integrated coupling optics on one of the devices 504A through 504E. For example, output port 501Aa is coupled to integrated coupling optics 502Aa. It is noted that the embodiment of FIG. 5A could be implemented using optical elements such as those used in the embodiment of FIG. 3A, instead of using the integrated optics as shown in the illustrated example.

By way of example, a DWDM light beam containing wavelengths λ₁ . . . λ₅ is shown input into the multi-ROADM device 500 at input port 501Cc. It is coupled to a waveguide dispersive element 505Cc of waveguide device 504C through integrated coupling optics 502Cc. The waveguide dispersive element consists of an array of waveguides having a predetermined optical length difference causing a wavelength dependent exit angle of the light upon exit of the waveguide device 504C. Therefore, the light is demultiplexed in 5 beams comprising respectively λ₁ to λ₅ referenced 507-1 to 507-5. On FIG. 5A, only beams 507-2 to 507-4 are shown for clarity. Those beams are substantially collimated in the plane perpendicular to the plane of the figure upon traversing cylindrical lens 506C, while being virtually unaffected in the plane of the figure. The main cylindrical lens 508 is used to route each beam 507-1 to 507-5 to a corresponding switching element 509-1 to 509-5, while virtually not impacting light propagation in the plane perpendicular to the plane of the figure. Those switching elements preferably consist of an array of tiltable mirrors capable of tilting both in the plane of the figure and in the perpendicular plane. When the mirrors are tilted in the plane of the figure, the light beams 507 can be routed to a particular horizontal location a to e. When the mirrors are tilted in the perpendicular plane, the light beams 507 can be routed to a particular waveguide device 504A to 504E in the waveguide stack 504. Therefore, an appropriate combination of tilt in the plane of the figure and perpendicular to the plane of the figure enables to route each beam 507-1 to 507-5 to any of the 25 possible waveguide dispersive elements 505Aa to 505Ee. In a preferred embodiment, the main cylindrical lens 508 is placed in-between the waveguide stack 504 and switching array 509 such that both the waveguide stack 504 and the switching array 509 lie in the vicinity of the focal plane of cylindrical lens 508. This arrangement guarantees that irrespective of the tilt of the MEMS mirrors 509-1 to 509-5, light beams 507-1 to 507-5 will always have an incident angle in the plane of the figure into any of the waveguide dispersive elements 505Aa to 505Ee that maximizes the coupling (i.e. the incident angle is substantially the same as the angle upon exit of the input waveguide dispersive element 505Cc).

The array of cylindrical lenses 506A to 506E is used to refocus and steer the light beams 507-1 to 507-5 to their respective waveguide device 504A to 504E depending on the switching pattern. In the case of the FIGS. 5A and 5B, λ₃ has been arbitrarily switched from waveguide dispersive element 505Cc to waveguide dispersive element 505Aa, λ₄ has been switched from 505Cc to 505Ee and λ₂ has been switched from 505Cc to 505Cb. After being coupled to their respective waveguide dispersive element 505, the light beams 507 are brought to their respective optical ports 501 through integrated coupling elements 502. In the particular case of the figure, the 3 depicted wavelengths λ₂ to λ₄ exit at respectively optical ports 501Cb, 501Aa, and 501Ee.

Referring again to FIG. 5B an important point on this figure is the arrangement of the array of cylindrical lenses 506A to 506E used to substantially collimate light beams 507-1 to 507-5 exiting from the waveguide dispersive element 505Cc in the plane of the figure, while not affecting light propagation in the perpendicular plane and used to substantially re-focus light beams 507-1 to 507-5 when they re-enter their respective waveguide dispersive element 505Aa to 505Ee depending on their switching pattern. The optical centre of cylindrical lenses 506A to 506E are aligned such that a 0 degree angle of incidence to the waveguide devices 504A to 504E is obtained when the switching mirrors 509 are tilting in the plane of FIG. 5B. For the particular embodiment depicted on FIGS. 5A and 5B, this is done by offsetting the centre of cylindrical lenses 506A, 506B, 506D and 506E by an appropriate amount.

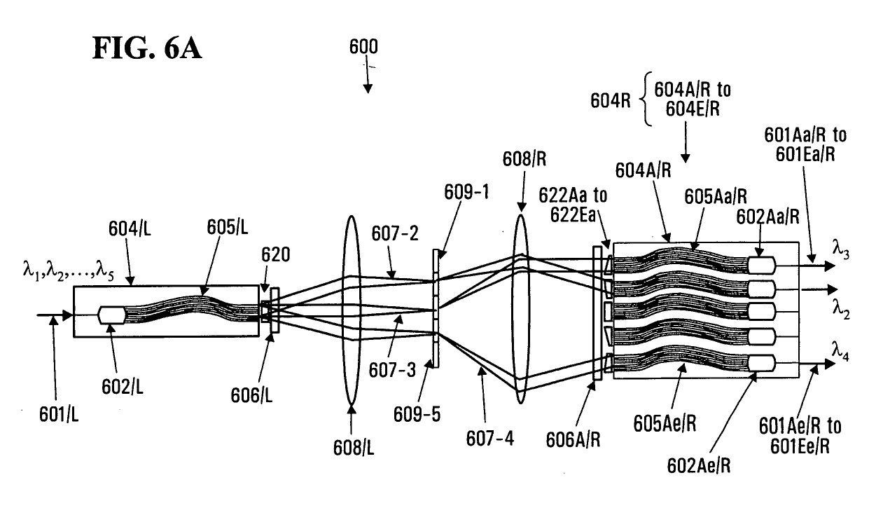

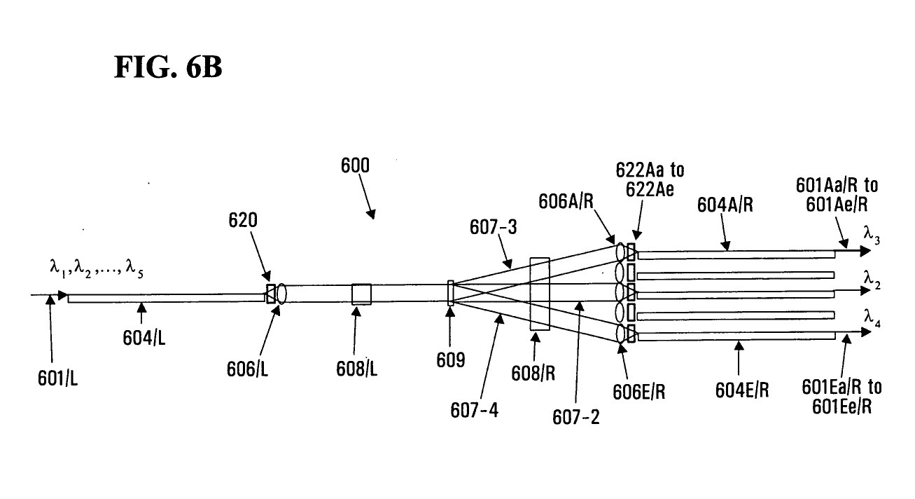

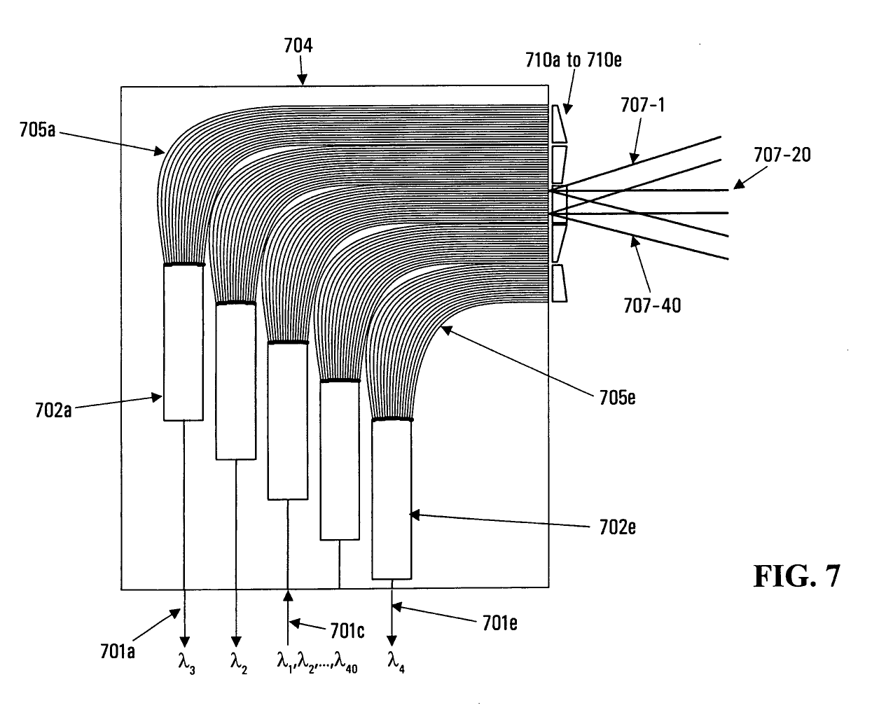

FIGS. 6A and 6B show another embodiment of the invention which features transmissive switching elements. This embodiment basically consists of the input port functionality of FIG. 4 on one side of an array of transmissive switching elements, on the other side of which is output port functionality analogous to that provided by device 500 of FIG. 5A. Other embodiments like a 400 type device connected to another 400 device, or a 500 type device connected to another 500 type device are possible, but are not shown.

FIG. 6A shows a top view of a transmissive multi-ROADM device 600 comprising a left part (with elements labeled with the suffix “/L” in the description) and a right part (with elements labeled with the suffix “/R” in the description) connected through an array of transmissive switching means 609. A DWDM multiplexed light beam comprising wavelengths λ₁ . . . λ₅ is input to the transmissive multi-ROADM at input port 601/L. It is coupled to waveguide dispersive element 605/L through integrated coupling element 602/L. A compensating wedge is provided at 620 to align this center wavelength of WDE 605/L with the optical axis of lens 608/L. Due to the dispersion imparted by waveguide dispersive element 605/L, the light exits the waveguide device 604/L with an angle dependent on wavelength. For clarity, only three wavelengths are shown as beams 607-2 to 607-4 corresponding to λ₂ to λ₄ respectively, although all five wavelength channels are present. The light beams 607-1 to 607-5 are substantially collimated in the plane perpendicular to the plane of the figure by cylindrical lens 606/L. The main cylindrical lens 608/L is used to route the different wavelength channels to a transmissive switching means array 609-1 to 609-5. These switching elements are capable of steering a light beam in transmission. For example, an optical phase array, an electro-hologram or other phase elements are known by one skilled in the art to provide this steering function. After being steered by the transmissive switching means 609-1 to 609-5, the light beams 607-1 to 607-5 are directed towards the waveguide stack 604/R by the main cylindrical lens 608/R. Preferably, the main cylindrical lenses 608/L and 608/R are assembled to provide a 4 f system, whereby the waveguide device 604/L and the array of switching means 609 are lying on the focal planes of cylindrical lens 608/L and the array of switching means 609 and the waveguide stack 604/R are lying on the focal planes of cylindrical lens 608/R. This arrangement guarantees that irrespective of the switching performed by switching elements 609, every wavelength channel 607-1 to 607-5 has the proper angle of incidence in the plane of the figure to maximize coupling into the waveguide stack 604/R. In the particular case when lens 608/L and 608/R have the same focal length, this corresponds to the angles of incidence to the waveguide stack 604/R being opposed to the exit angles from waveguide device 604/L and the waveguide dispersive elements 605/R being mirror images of the waveguide dispersive element 605/L. Other combinations using different focal lengths for cylindrical lenses 608/L and 608/R and different designs for waveguide dispersive elements 605/L and 605/R are possible by proper design. The array of cylindrical lenses 606A/R to 606E/R is used to refocus the light beams 607-1 to 607-5 into their respective waveguide dispersive element 605/R depending upon switching. A two dimensional array of compensating wedges 622Aa to 622Ea is provided to compensate the dispersive elements or to compensate the dispersive elements in combination with their relative positioning error with other optical components. In the example shown on FIG. 6, the wavelength channels λ₂ to λ₄ are arbitrarily routed respectively to waveguide dispersive elements 605Cb/R, 605Aa/R and 605Ee/R. After being routed to their respective waveguide dispersive elements, the light beams 607-1 to 607-5 are connected to their respective optical ports 601/R through respective integrated coupling means 602/R.

FIG. 6B shows a side view of the embodiment of FIG. 6A. The array of compensating wedges (shown as 622Aa to 622Ae in the side view) includes wedges for each dispersive element and each waveguide device. It shows in particular that the cylindrical lens 606/L is used to substantially collimate the light beams 607-1 to 607-5 exiting the waveguide device 604/L. After traversing the array of transmissive switching means 609, the light beams 607-1 to 607-5 are steered in two dimensions. In the plane of FIG. 6B, the beam 607-3 is tilted upwards towards waveguide device 604A/R, the beam 607-4 is tilted downwards towards waveguide device 604E/R, while the beam 607-2 is not deflected and is connected to waveguide device 604C/R. In order to couple efficiently to their respective waveguide device 604/R, the light beam 607-1 to 607-5 are re-focussed through the array of cylindrical lenses 606/R. In order to couple efficiently to waveguide device 604/R, it is also necessary that the light beams 607-1 to 607-5 be parallel to the substrates of their corresponding waveguide devices 604/R. This is achieved by proper positioning of the optical centre of cylindrical lenses 606/R. In the example shown on FIG. 6B where all waveguide substrates 604A/R to 604E/R are parallel and horizontal, this is achieved by having the optical centre of cylindrical lenses 606A/R, 606B/R, 606D/R, and 606E/R offset by a proper amount compared to the waveguide core locations.

FIG. 7 shows an example schematic layout of a waveguide device 704 containing an array of waveguide dispersive elements 705 designed for a 40 channel system with 100 GHz spacing. This might be used to implement waveguide device 404 of FIG. 4A or devices 504A through 504E of FIG. 5A for example. An array of wedges 710a to 710e such as described previously is shown consisting of one wedge per dispersive arrangement to compensate the dispersive elements or to compensate the dispersive elements in combination with their relative positioning error with optical components. The waveguide device 704 consists of optical ports 701a to 701e coupled to waveguide dispersive elements 705a to 705e through integrated coupling elements 702a to 702e. The coupling elements 702a to 702e each comprise a free propagating region in the plane of the figure, guiding the light only in the perpendicular plane. The length of this free propagation region in this example is 13.63 mm, ending with an arc of 13.63 mm radius of curvature. The waveguide dispersive elements 705a to 705e each consist of an array of 250 waveguides (not all shown) connected at one end to this arc with a spacing of 12 microns and on the other end to the facet of the waveguide device 704 with a spacing of 12 microns. The 250 waveguides are arranged such that there is a constant physical path length difference between each consecutive waveguide of 25.55 microns. With these design parameters, a 40 channel 100 GHz spacing DWDM multiplexed light beam input at 701c into the waveguide device 704 is demultiplexed into 40 light beams 707-1 to 707-40 upon exit of the waveguide dispersive element 705c with an angle depending on wavelength of about 1.4 radian per micron. The derivation of the chosen design parameters are similar to those required for an AWG and is known to one skilled in the art (see for example H. Takahashi et al., Journal of Lightwave Technology, Vol. 12, No. 6, pp. 989-995, 1994) with the only difference that the array of waveguides 705 ends on the straight facet of waveguide device 704.

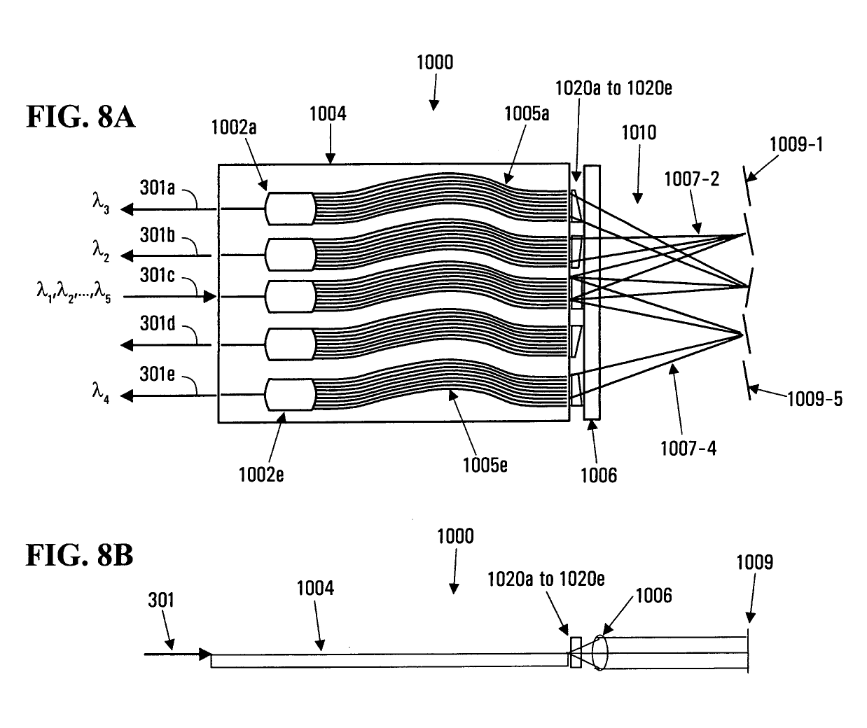

FIG. 8A shows the top view of another embodiment as per the invention generally indicated at 1000. This embodiment is similar to that of FIG. 4A in that a set of ports 301a through 301e are provided which are connected through integrated optical coupling means to waveguide arrays. In this example, the integrated coupling means are designated with reference numerals 1002a through 1002e and the waveguide arrays are designated as 1005a through 1005e, forming part of a waveguide device 1004. This embodiment differs from that of FIG. 4A in that there is no main cylindrical lens element 308, but rather the functionality of that lens is integrated with the waveguide dispersive elements. This is achieved by putting the appropriate phase profile inside the waveguide dispersive element. In the case of a waveguide array, this is usually achieved through the addition of an extra parabolic phase term to the linear phase term required for dispersion only. Such a focussing and dispersive arrangement of a waveguide element is described, for example, in: M. K. Smit, Electronics Letters, Vol. 24, pp. 385-386, 1988. In the particular case of the present invention though, the focussing parameters of each of the waveguide dispersive element array 1005a to 1005e have to be computed such that all wavelength channels 1007-1 through 1007-4 are focussed to the same point on the switching array 1009-1 to 1009-5. This is achieved by putting an appropriate offset in the parabolic phase profile for each respective waveguide dispersive element. An array of wedges 1020a to 1020e such as described previously is shown consisting of one wedge per dispersive arrangement to compensate the dispersive elements or to compensate the dispersive elements in combination with their relative positioning error with optical components. Cylindrical lens 1006 performs the same function as lens 306 of FIG. 4A. For the description of FIG. 8A, a five wavelengths system has been shown with an array of five waveguide dispersive elements, although other combinations are possible.

By way of example, an optical signal containing λ₁ to λ₅ is input to the wavelength switch device 1000 through optical port 301c. It is coupled to integrated lens-waveguide dispersive element 1005c of waveguide device 1004 through integrated coupling optics 1002c. The preferred embodiment of the waveguide dispersive element is an array of waveguide having a predetermined phase relationship with each other. The linear term in this phase profile accounts for dispersion, while the second order terms add focussing power. Therefore, the light beams exiting the waveguide device 1004 have a diversity of angles depending on wavelengths and are all focussed on the focal plane of integrated lens-waveguide dispersive element 1005c. For clarity, only three such beams 1007-2 to 1007-4 are shown on the figure. While the beams are focussed in the plane of the figure through the non-linear phase profile imparted on the array of waveguides constituting the integrated lens-waveguide dispersive element 1005c, the light beams 1007-1 to 1007-5 are diverging in the plane perpendicular to that of the figure. Therefore, a cylindrical lens 1006 is provided that collimates the beam 1007-1 to 1007-5 in the plane perpendicular to that of the figure, while substantially not affecting light propagation in the plane of the figure. In the plane of the figure, there is no optical element having power, therefore this region labeled 1010 is referred to as a free-space propagation region.

As mentioned above, all integrated lens-waveguide dispersive elements 1005a to 1005e are designed such that all wavelength channels are focussed onto the same point irrespective of the lens-waveguide dispersive elements they are propagating through. This is achieved through appropriate design of the non-linear terms within the phase profile inside each of the waveguide arrays constituting the integrated lens-waveguide dispersive elements 1005a to 1005e. In particular, the switching means array 1009-1 to 1009-5 is lying substantially in the common focal plane of these integrated lens-waveguide dispersive elements 1005a to 1005e.

The switching means 1009-1 to 1009-5 are shown on FIG. 8A as micro-mirrors, although other arrangements are possible with transmissive switching means for example. Upon tilting of the micro-mirrors, the light beams 1007-1 to 1007-5 can be routed from the middle integrated lens-waveguide dispersive element 1005c to any of the array of integrated lens-waveguide dispersive elements 1005a to 1005e. With the particular geometry chosen for this embodiment, the coupling efficiency is maximum. This will be explained in the case of light beam 1007-2, but is true simultaneously for all light beams 1007-1 to 1007-5.

Light beam 1007-2 corresponds to wavelength channel λ₂ as it exits the waveguide device 1004 through the end facet of integrated lens-waveguide dispersive element 1005c. Given the design parameters mentioned above, it is focussed on switching element 1009-2. If this light beam would have originated from integrated lens-waveguide dispersive element 1005b, it would also have been focussed to switching element 1009-2, due to the particular of the optical design of the integrated lens-waveguide dispersive element 1005b. Therefore, one can establish an optical path from 1005c to 1005b for wavelength channel λ₂ by tilting micro-mirror 1009-2 by an appropriate amount. This is essentially true for all wavelength channels and all integrated lens-waveguide dispersive elements.

Upon coupling back to waveguide device 1004, the light beams 1007-1 to 1007-5 are connected to their respective output ports 301a to 301e depending on the switching pattern chosen for switch array 1009, through integrated optics coupling means 1002a to 1002e. In the case shown on FIG. 8A, wavelength channel λ₂ is directed to port 301b, wavelength channel λ₃ is directed to port 301a and wavelength channel λ₄ is directed to port 301e. Ideally, the waveguide dispersive elements 1005a to 1005e are to be fabricated precisely according to design specifications such that light beams 1007-1 to 1007-5 would all be focussed on the same spot as array 1009-1 to 1009-5 regardless of which WDE 1005a to 1005e they originate from. In the presence of small fabrication errors, wedges 1020a to 1020e are inserted to compensate.

FIG. 8B shows a side view of the embodiment shown on FIG. 8A. In this case, there is only one cylindrical lens 1006 used to substantially collimate light beams 1007-1 to 1007-5 upon exit of the waveguide device 1004 and to re-focus them on their way back to waveguide device 1004.

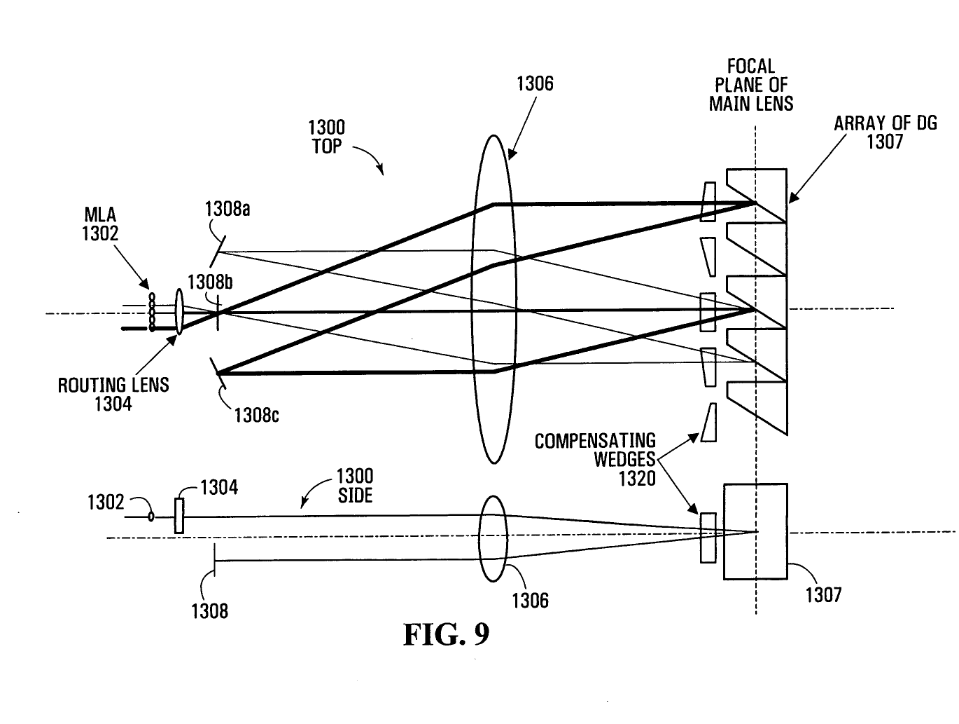

Referring now to FIG. 9, shown is a system block diagram of a free-space embodiment of a wavelength selective optical switch provided by the invention. This embodiment employs an array of reflective diffraction gratings instead of waveguide devices as employed in the previous embodiments. More generally, non-transmissive dispersive elements can be employed with this arrangement. The figure shows a set of MLA's (microlens array) 1302, the output of which passes through a routing lens 1304. The top view of the device is generally indicated at 1300TOP and the side view is generally indicated at 1300SIDE.

The output of the routing lens 1304 passes through free-space to a main lens 1306 which routes each of the ports to a respective diffraction grating forming part of an array of diffraction gratings 1307. The array of diffraction gratings reflect the incoming light of each port according to wavelength. There is an array of switching means 1308 shown to consist of tiltable mirrors 1308a, 1308b and 1308c. There would be a respective switching element for each wavelength. It is noted that the switching elements 1308 are not in the same horizontal plane as the routing lens 1304. This can be most clearly seen in the side view 1300SIDE. Each switching element performs a switching of light of a given wavelength from one input port to another optical port by tilting of the mirror. An array of wedges 1320 such as described previously is shown consisting of one wedge per dispersive arrangement to compensate the dispersive elements or to compensate the dispersive elements in combination with their relative positioning error with optical components.

The compensating wedge array is inserted in front of the diffraction grating array to compensate for fabrication and positioning errors of all elements in the path (main lens, diffraction gratings, etc.) such that each wavelength channel if launched through all optical ports overlap on a respective MEMS mirror.

The operation of FIG. 9 is similar to that of previous embodiments. One of the ports is designated as an input port and the other ports are output ports. By appropriate tilting of the mirrors in array 1308, each wavelength of a multi-wavelength input signal received at the input port can be switched to any of the output ports.

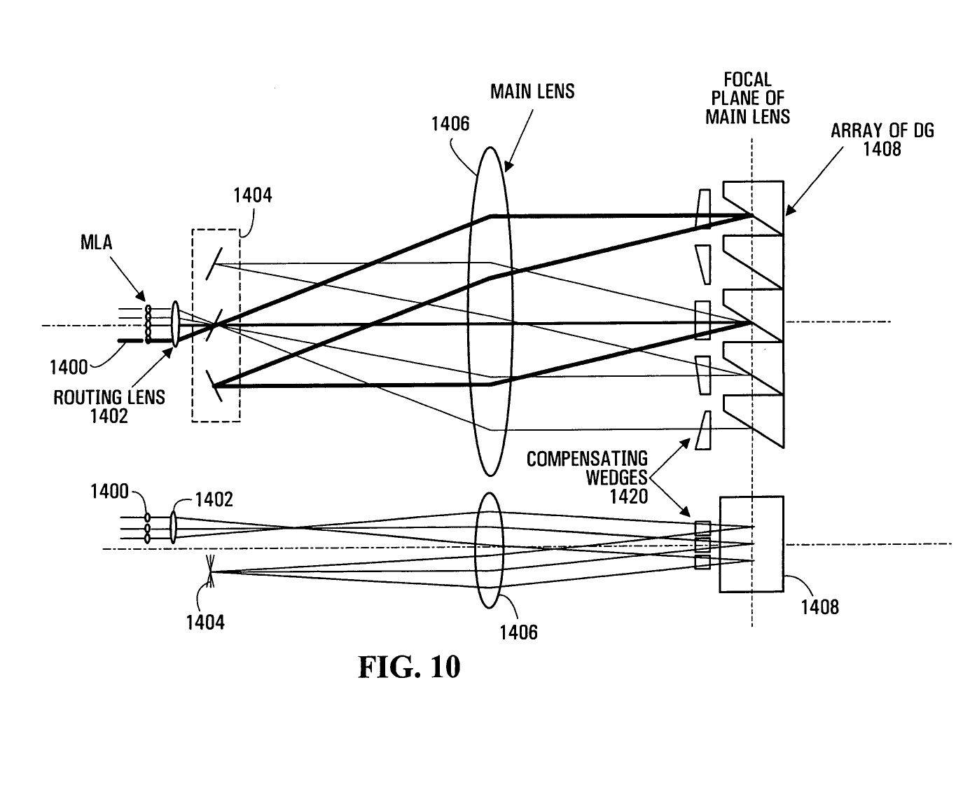

FIG. 10 is an implementation similar to that of FIG. 9 except that in this case, there is a two dimensional array of ports, generally indicated at 1400 optically connected through routing lens 1402 to the main lens 1406 and array of diffraction gratings 1408. Switching/routing is performed using routing elements generally indicated at 1404. An array of wedges 1420 such as described previously is shown consisting of one wedge per dispersive arrangement to compensate the dispersive elements or to compensate the dispersive elements in combination with with their relative positioning error with optical components. This embodiment is similar functionally to the embodiment of FIG. 5A, but with diffraction gratings used as dispersive elements.

The above-described embodiments have employed either an array of waveguides or diffraction gratings as the dispersive elements. It is noted that any appropriate dispersive arrangement type might be employed. For example reflective, transmissive, echelle, echellon, or grisms, to name a few examples. Array waveguides and echelle waveguide gratings might be employed. Prisms might instead be employed for the dispersive elements. More generally, any dispersive arrangements that can achieve the desired wavelength dependent function may be employed by embodiments of the invention.

The described embodiments have featured MEMS mirror arrays to perform the switching of wavelengths. More generally, any appropriate switching means may be used. For example, liquid crystal beams steering elements (phase array), acousto-optic beam deflectors, solid-state phase array, controllable holograms, periodically polled Lithium Niobate beam deflectors.

The preceding descriptions have only mentioned switching applications in which routing elements having a switching function are used to established re-programmable light paths. In other embodiments fixed arrangements are also possible to establish permanent light paths using routing elements which do not switch. The applications for such fixed devices would be for fixed demultiplexers, filters, band filters, interleavers, etc.

Many of the above-described embodiments have all focussed on the redirection of light from an input to an output port, thereby realizing wavelength selective switching. Another embodiment of the invention provides an integration platform having three or more ports, a dispersive element per port, and a bulk optical element having optical power in communication with all of the ports. For example, by replacing the switching elements with appropriate light processing elements, a channel selective filtering function, limiting, optical sensing, channel attenuation, polarization state change application can be achieved.

The embodiments of FIGS. 3 to 10 show WSS with main lens for embodiments with reflection switching elements, and two main lenses for embodiments with transmissive switching elements. More generally, for WSS applications of this type, one or more lenses can be used to achieve these functions. For example, there might be a respective lens per dispersive element. More generally still, any WSS implementations that make use of the compensated array of dispersive elements are contemplated.

Installation Methods

While the embodiments described below are particularly relevant for WDEs, the concepts have more general application to any dispersive element arrays, this including both waveguide and non-waveguide dispersive element arrays. An example of a non-waveguide dispersive elements array is an array of diffraction gratings.

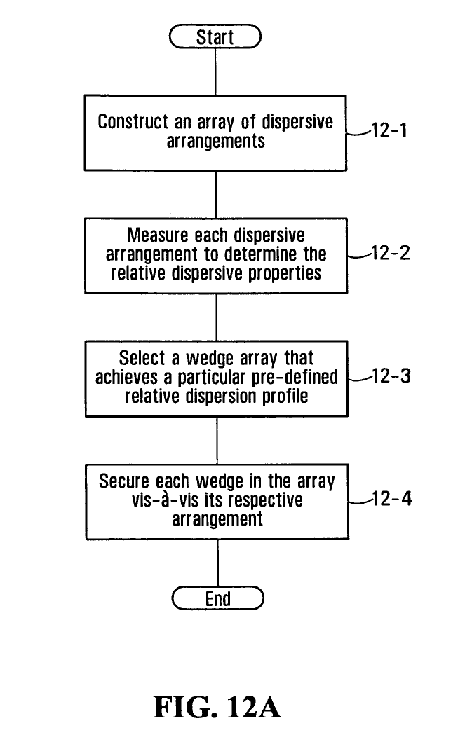

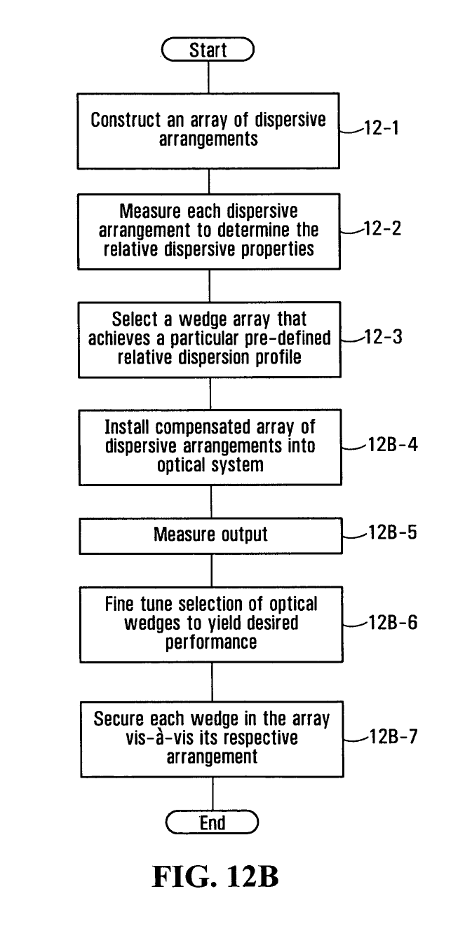

A preferred method of implementation will now be described with reference to FIG. 12A. To begin, an array of dispersive arrangements is constructed using any appropriate technology/process in step 12-1. Examples include monolithic and/or assembly processes. Each dispersive arrangement is then measured to determine the relative dispersive properties of the arrangements in step 12-2. On the basis of the relative dispersive properties as measured, an ideal correction in terms of wedge angle can be determined for each dispersive element to yield a desired dispersion profile. A wedge array is then selected to achieve a particular pre-defined relative dispersion profile at step 12-3. For example, the pre-defined relative dispersion profile may be that all dispersive properties are aligned such that for a given incoming angle of incidence on each dispersive arrangement, all outgoing angles are made parallel. However, other pre-defined patterns can be realized through a proper wedge array selection to compensate for imperfections in other parts of the optical system containing the dispersive element array. For example, the alignment of ports coupled to the dispersive arrangements or aberrations of lenses coupled to the dispersive arrangements may also be at least partially compensated for with the wedge array. At step 12-4 each wedge in the array is secured vis-á-vis its respective dispersive arrangement in the array.

More generally, in steps 12-3 and 12-4 optical compensators are selected to achieve the pre-defined relative dispersion profile, wedges being just one particular example of such compensators, and the optical compensators are secured vis-á-vis the respective dispersive arrangements.

In some embodiments, a set of wedges having a selection of discrete wedge angles is supplied with a wedge angle increment small enough to enable a performance specification to be met (for example, that the remaining mispointing angular error is less than 10 arcsec), with the selection covering a range of possible deviations due to tolerance in fabrication and positioning. In this case, the particular wedge that is selected is the wedge that is closest to the ideal value that was determined for a given dispersive element.

In a very specific example, if the specified tolerance in fabrication is a 3-sigma tolerance of +/−1 arc minute, the specification that a remaining mispointing error be less than 10 arcsec can be achieved with 6 different wedges from 0 to 60 arcsec in a 10 arcsec increment. Note that + or − values are obtained by positioning the wedges in opposed orientations.

This technique works because for small wedges (less than <1 degree) the positioning tolerance of the wedge has a negligible impact on the angular pointing accuracy. Therefore, a very simple wedge holder can be designed and put in position very inexpensively.

Another method of choosing wedges will be described with reference to FIG. 12B. In this embodiment, method steps 12-1 to 12-3 as described above with reference to FIG. 12A are used to choose a wedge array for an array of dispersive arrangements. Then, the array of dispersive arrangements and the wedge array are installed into an optical system at step 12B-4. At step 12B-5, the output is measured. Any measurement that allows a determination of whether the wedge array is performing properly can be employed. At step 12B-6, the selection of the wedges in the wedge array is fine tuned to yield the desired performance. This may involve changing one wedge at a time for example. Finally, at step 12B-7, the wedges are secured in place.

Glue Wedge

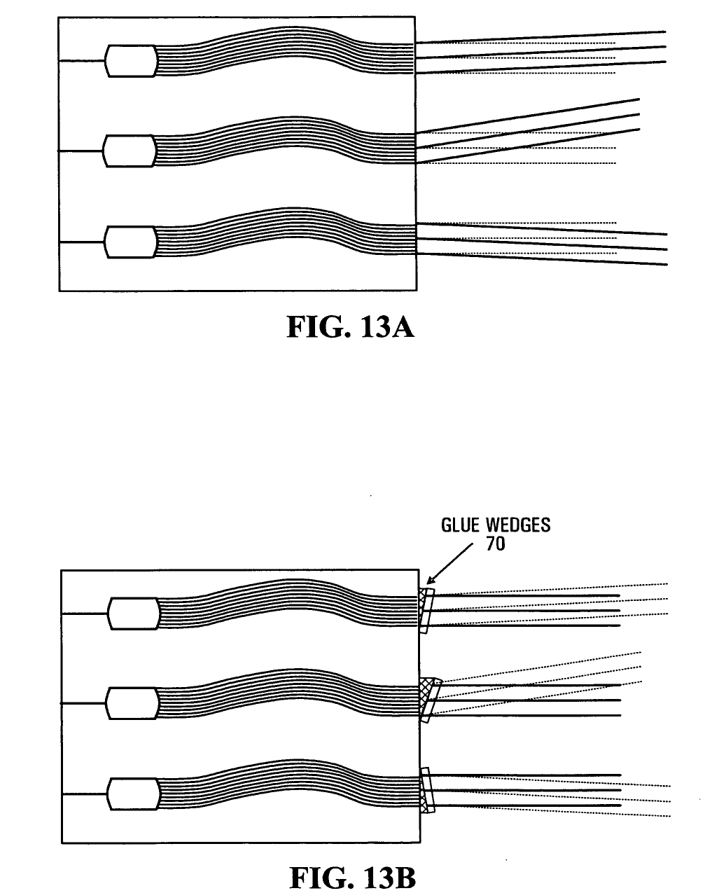

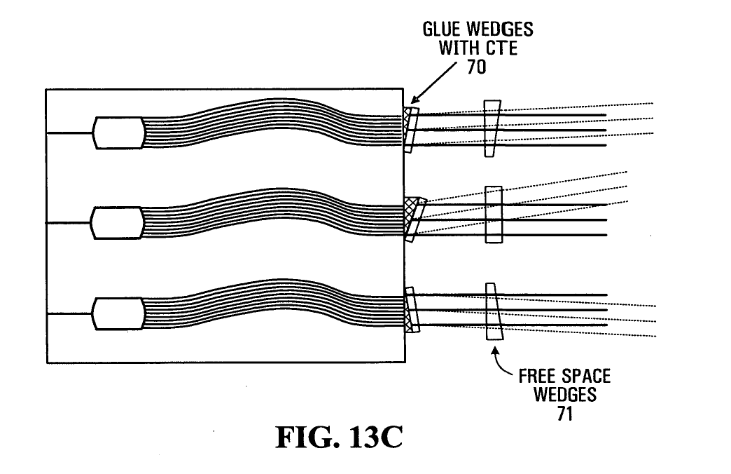

FIGS. 13A and 13B show a different embodiment of the invention. Instead of using transmissive glass wedges held in the free-space region after the WDE array as in FIG. 1C, a similar result is achieved by gluing some small parallel plates, preferably glass plates, to the waveguide facet and inducing a wedge in the glue used to attach the parallel plates to the waveguide facet. More generally, the plates can be glued to a supporting element. The supporting element can be a waveguide facet as above or otherwise. An example is shown in FIG. 13B which shows three such glue wedges 70 installed.

With this method the alignment tolerance of the glue wedge is on the order of the resolution required (for the same example as used above, would require a control of the glue wedge to within 10 arcsec), vs. up to a degree in the free-space wedge. This is because once the free-space wedge is fabricated, it can be held in place with no tolerance. The advantage on the other hand of using a glued on wedge is that a finer granularity can be achieved since the glue wedge can be aligned actively to any value required (as opposed to the closest wedge in a set for the free space case) and that the glue material can be chosen so as to expand/contract with temperature to compensate for the thermal dependence of the λc of each WDE. Furthermore, it is often necessary to apply an anti-reflection coating at the facet of the WDE, so there is often a parallel plate glued on the facet of the WDE. In the case of free-space wedge array as per FIG. 1C, the parallel plate with the anti-reflection coating can be glued flat on the WDE facet, with the minimum glue gap and no glue wedge. In the case of glue wedges as per FIG. 13B, the parallel plate with the anti-reflection coating is split in smaller pieces, each corresponding to a respective WDE and the glue gap is individually aligned to induce the proper glue wedge to align the λc of each WDE to a pre-defined pattern.

Compensation for Thermal Sensitivity

In another embodiment, wedge material is selected that has a predefined shift in characteristic with respect to temperature so as to render the whole system to be substantially athermal.

Thermal sensitivity of the system as a whole is measured, and then a shift is introduced using the wedges that is the opposite to that of the rest of the system.

In a first example of this, the wedges are made of a material having an index of refraction that changes as a function of temperature is used to compensate for thermal shift. Materials that have this type of behavior are well known. This can be employed for free space and glue wedge embodiments.

In a second example, the wedges are made of a material that has a coefficient of thermal expansion (CTE) that can compensate for thermal shift. A wedge with a given CTE will change its wedge angle slightly as a function of temperature. The material is selected such that the change in angle as a function of temperature will correct for temperature sensitivity elsewhere in the system. This can be employed for both free space and glue wedge embodiments.

In another embodiment, a combination of wedges is employed for each dispersive element. One of the wedges is selected to yield the desired dispersion profile as discussed in detail above. The other of the wedges is selected to yield the desired temperature insensitivity. In a particular implementation, free space wedges are used for the dispersion profile, and glue wedges having a selected CTE are used to yield/improve temperature insensitivity. An example of this is shown in FIG. 13C where there are two sets of wedges. The first set of wedges 70 is a set of glue wedges with appropriate CTE. The second set of wedges 71 is a set of free space wedges selected to yield the desired dispersion profile. This approach can more generally be applied for any set of dispersive arrangements that are to be compensated.

Polarization Sensitive Dispersive Arrangements

In the case of a polarization sensitive dispersive arrangement, birefringent wedges can be used to simultaneously compensate for wavelength center error and polarization sensitivity of the dispersive arrangement. In an example implementation, each such birefringent wedge consists of two wedge shaped pieces of birefringent material glued together with appropriate relative orientation.

Pairs of Lenses

In yet another embodiment, rather than using a set of wedges, either discrete free space ones selected from a set or glued on the waveguide facets to allow active positioning (and thus continuous tuning), a pair of lens elements, preferably cylindrical lenses, one negative and one positive, is employed for each dispersive element to steer light rays in transmission. By appropriately installing each pair, with an offset between the lenses selected on a per port basis, continuous tuning of the angular corrections of each of the dispersive arrangements in the array can be achieved. This can be achieved with a set of identical pairs of lenses.

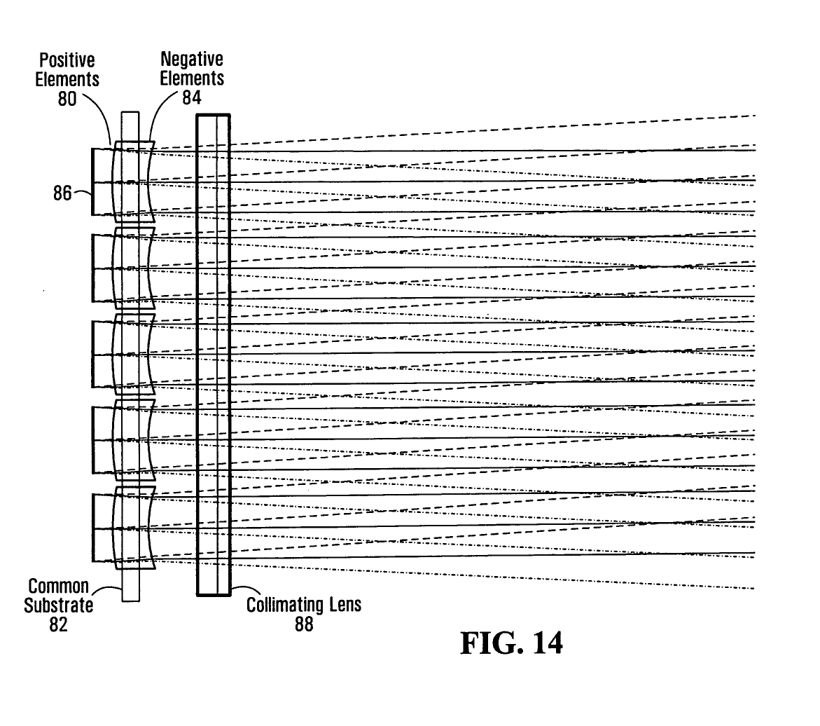

A further advantage of this approach is an additional degree of freedom with respect to focussing properties of the lens pairs. In this case, lens pairs with differing focussing properties are selected. This allows a predefined respective dispersion profile across the dispersive arrangement arrays to be achieved using the offset between the lenses of a given pair, and also allows fine tuning of the amount of focussing power across the dispersive array, compensating for further errors in the other elements in the overall optical system. For example, for the embodiment of FIG. 5A, there might be the main lens 508 might have a focal length error across its aperture that can be compensated using this technique. The additional degree of freedom refers to the fact that the power of the cylinders can be varied to compensate for the port-dependent variation in the EFL for the (switching) lens. Because the main lens is an acylinder, the EFL changes as one goes off-axis, so the dispersion of the waveguide array also changes slightly. Referring now to FIG. 14, shown is a schematic diagram of an example implementation of this approach. Shown is a common substrate 82 (more generally any appropriate support structure) to which is mounted a set of fixed positive elements 80, and a set of sliding negative elements 84. In the illustrated example, the sets 80,84 contain 5 elements each, one for each incoming waveguide facet 86. More generally, arrays of any size can be implemented. Also shown is a collimating lens 88. This can be considered to be outside or part of the actual compensating arrangement.

Preferably, the positive elements 80 are bonded (or otherwise affixed) on one side of the supporting plate (toward the waveguides). These can be installed at an appropriate spacing of corresponding to the dispersive arrangement spacing. The negative elements 84 are placed on the other side of the plate and moved into position to have an offset with respect to the corresponding positive lens until the resulting tilt is right. Then the negative lens is affixed in place, for example using in-situ UV curing. The tuning mechanism is realized by moving each port's negative element to a position which compensates for that port's center-wavelength diffraction angle error+the tilt required to compensate for a downstream lens aberration. Placing the positive element first means reducing the aperture at the negative lens, so that for the same nominal spacing of the ports, there is more room to maneuver the negative elements. Also, by choosing a port-dependent ROC (Radius of Curvature) on the negative elements, the pupil-position-dependent EFL (Effective Focal Length) can be compensated.

More generally, any method of installing each pair of elements can be employed such that each positive element is installed vis-á-vis the corresponding negative element such that the resulting separation of the respective optical axes realizes the desired correction in the relative dispersion profiles.

Preferably, both elements are simple cylinders, not acylinders. The following is a set of design parameters for a very particular implementation in which there are 5 ports, separated by 4.5 mm: Each positive element is common, with a ROC=7.85 mm in this case. Each negative element is installed with a 100 μm translation capability. The tuning range can be set to any range desired (within reason) by suitable choice of this RoC.

Each negative element can be selected to have a power that compensates for the varying EFL of a downstream lens (such as a switching lens), as a function of the off-axis position. If an input optical field is centered precisely on the optical axis of the lens (in this case an acylinder), then it is on-axis. Whatever distance the center of this field is from the optical axis, in the powered direction of the lens, is referred to as its “off-axis” position. Because we are considering (cylindrical) lenses with power in only one dimension, the vertex of the surface actually spans a line, so the off-axis position refers to the distance from that line to the center of the incident optical field.

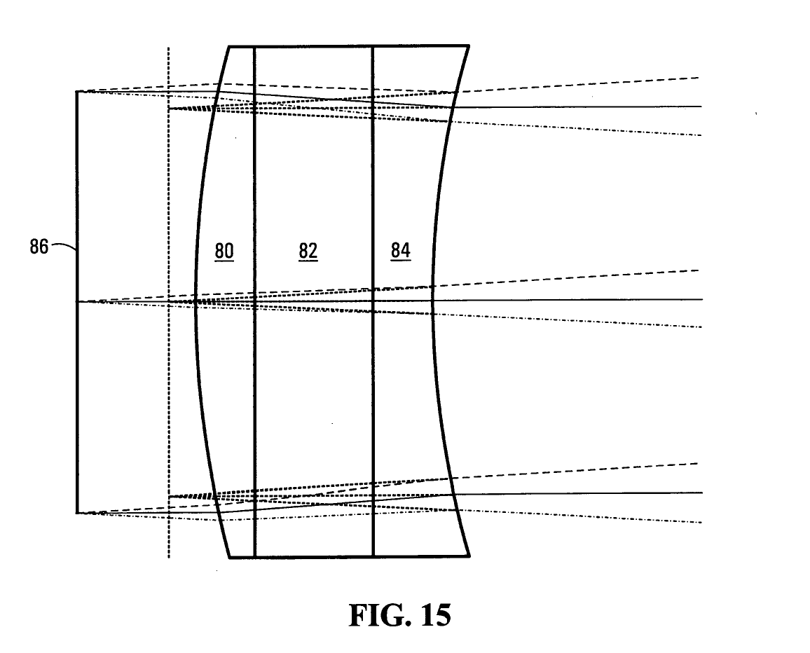

FIG. 15 shows a detailed view of a port (e.g. the center port) requiring no tilt correction. The dotted lines represent the virtual source trajectories, launched virtually from the dotted black line (the virtual object plane). Notice that the virtual object is about 10% smaller than the original. This in no way affects the spectral resolution of the system, because (as a result of the Lagrange invariant) the angular dispersion is increased by a proportional amount.

For implementations with a downstream MEMs array, for example the embodiment of FIG. 5A, this change in the virtual object size effects the size of the downstream MEMS array. If the virtual object size decreases by 10%, then the downstream MEMs array can be 10% longer.

If it is preferred not to change a downstream MEMS design, then waveguide arrays with a 10% reduced angular dispersion can be employed.

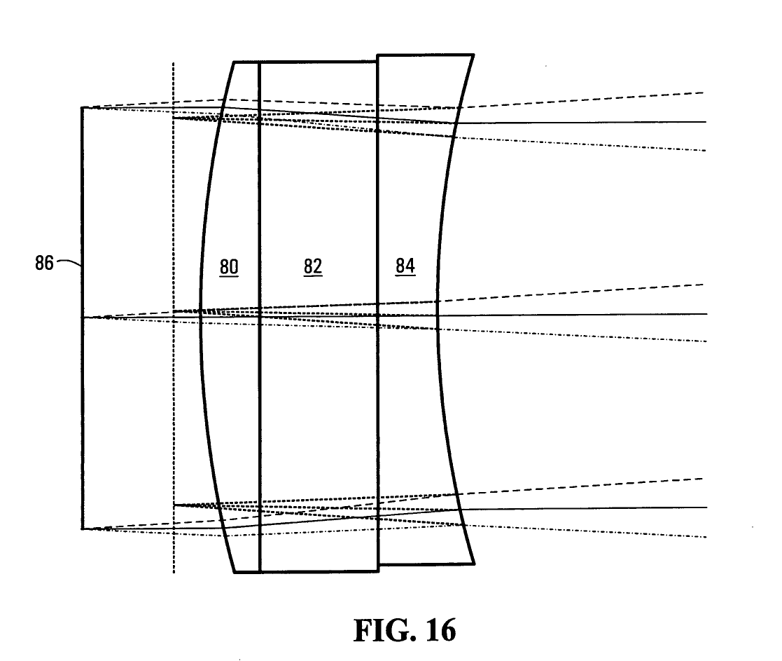

FIG. 16 shows 200 μm offset of the negative element 84, compared to the positive element 80. For the 7.28 mm ROC represented in this (fused silica) design, the tilt is 0.7 degrees. Thus, for a rather large displacement of the negative lens, there is a relatively small tilt of the virtual object.

Numerous modifications and variations of the present invention are possible in light of the above teachings. It is therefore to be understood that within the scope of the appended claims, the invention may be practiced otherwise than as specifically described herein.

We claim:

1. An apparatus comprising:
an array of dispersive arrangements;
an array of optical compensators arranged with respect to the array of dispersive arrangements so as to align dispersion angles corresponding to at least one wavelength to produce a defined relative dispersion profile.

2. The apparatus of claim 1 wherein each optical compensator of the array of optical compensators comprises a wedge.

3. The apparatus of claim 2 wherein each wedge has one of a discrete set of angles.

4. The apparatus of claim 2 wherein each wedge comprises two wedge shaped pieces of birefringent material.

5. The apparatus of claim 1 wherein each optical compensator comprises a plate glued to a supporting element with a wedge induced in the glue used to secure the plate to the supporting element.

6. The apparatus of claim 1 wherein each dispersive arrangement comprises a waveguide dispersive arrangement.

7. The apparatus of claim 5 wherein each dispersive arrangement comprises a waveguide dispersive arrangement having a waveguide facet, and wherein the supporting element for the glass plate comprises the waveguide facet.

8. The apparatus of claim 1 wherein each dispersive arrangement comprises a diffraction grating.

9. The apparatus of claim 1 wherein each optical compensator comprises:
a positive lens element and a negative lens element arranged in sequence.

10. The apparatus of claim 9 wherein the positive lens element and the negative lens element are cylindrical lens elements.

11. The apparatus of claim 10 further comprising a support structure to which the negative cylindrical lenses are affixed, and to which the positive cylindrical lenses are affixed.

12. The apparatus of claim 1 wherein the optical wedges have coefficients of thermal expansion selected to reduce temperature sensitivity of a system within which the array of wedges is installed.

13. The apparatus of claim 5 wherein the glue has coefficients of thermal expansion selected to reduce temperature sensitivity of a system within which the array of wedges is installed.

14. The apparatus of claim 2 wherein each optical compensator further comprises a plate glued to a supporting element with a wedge induced in the glue used to secure the plate to the supporting element, the glue having coefficient(s) of expansion selected to reduce temperature sensitivity of a system within which the array of wedges is installed.

15. A waveguide selective switch comprising the apparatus of claim 1.

16. A method comprising:
constructing an array of dispersive arrangements;
measuring each dispersive arrangement to determine the relative dispersive properties of the arrangements;
selecting an array of optical compensators to achieve a particular defined relative dispersion profile.

17. The method of claim 16 further comprising:
installing the array of optical compensators with respect to the array of dispersive arrangements.

18. The method of claim 16 wherein selecting an array of optical compensators to achieve a particular defined relative dispersion profile comprises:
selecting an array of wedge each having one of a set of discrete wedge angles.

19. The method of claim 18 wherein the discrete angle of each wedge selected is the discrete angle that is closest to an ideal wedge angle.

20. The method of claim 17 wherein selecting and installing comprise:
gluing a glass plate to each dispersive arrangement and inducing a wedge in the glue.

21. The method of claim 16 wherein selecting an array of optical compensators comprises providing pairs of lens elements, each pair comprising one negative element and one positive element; and
installing each positive element vis-á-vis the negative element such that a resulting separation of respective optical axes of the pair of lenses realizes a desired correction in the relative dispersive profiles.

22. The method of claim 21 wherein the lens elements are cylindrical lens elements.

23. The method of claim 22 further comprising:
selecting pairs of cylindrical lens elements with differing focussing properties.

24. The method of claim 21 wherein installing comprises:
installing each positive element in a fixed position;
adjusting the negative element in situ and then affixing it in place.

25. A method comprising:
processing a plurality of optical signals with an array of dispersive elements;
processing the signals with an array of optical compensators arranged with respect to the array of dispersive arrangements so as to align dispersion angles corresponding to at least one wavelength to produce a defined relative dispersion profile.
